(19) United States
(12) Patent Application Publication
(10) Pub. No.: US 2025/0344213 A1
(43) Pub. Date: Nov. 6, 2025

(54) CONTROL SIGNALING FOR MULTIPLE ANTENNA PANEL PHYSICAL UPLINK CONTROL CHANNEL TRANSMISSION

(71) Applicant: Apple Inc., Cupertino, CA (US)

(72) Inventors: Yushu Zhang, Beijing (CN); Haitong Sun, Cupertino, CA (US); Hong He, San Jose, CA (US); Huaning Niu, San Jose, CA (US); Weidong Yang, San Diego, CA (US); Seyed Ali Akbar Fakoorian, San Diego, CA (US); Wei Zeng, Saratoga, CA (US); Chunxuan Ye, San Diego, CA (US); Chunhai Yao, Beijing (CN); Dawei Zhang, Saratoga, CA (US)

(21) Appl. No.: 18/860,844

(22) PCT Filed: Apr. 29, 2022
(86) PCT No.: PCT/CN2022/090256

§ 371 Date: Oct. 28, 2024

(51) Int. Cl. H04W 72/21; H04B 7/0404

(52) U.S. Cl. CPC H04W 72/21; H04B 7/0404

(57) ABSTRACT

A user equipment (UE) includes a transceiver and a processor. The processor is configured to receive, from a base station, via the transceiver, an indication of a physical uplink control channel (PUCCH) transmission scheme. The PUCCH transmission scheme indicates that different PUCCHs are to be transmitted in at least one of a frequency division multiplexing (FDM) manner or a spatial division multiplexing (SDM) manner using multiple beams. The multiple beams are formed by two or more antenna panels in the set of antenna panels. The processor is also configured to determine the different PUCCHs to be transmitted based at least in part on the indication of the PUCCH transmission scheme, and transmit the different PUCCHs, via the transceiver, using the PUCCH transmission scheme.

### TECHNICAL FIELD

This application relates generally to wireless communication systems, including methods and implementations for transmitting a physical uplink control channel (PUCCH) from each of multiple antenna panels.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIGS. 2A and 2B show examples of how uplink control information (UCI) may be transmitted over a PUCCH with repetition.

FIG. 3 shows an example method of wireless communication by a UE, which method may be used to transmit different PUCCHs, using multiple antenna panels, in at least one of a frequency division multiplexing (FDM) manner or a spatial division multiplexing (SDM) manner.

FIGS. 4A-4C show examples of how a first PUCCH may be transmitted from a first antenna panel, on a first beam, using a first set of frequency resources within a set of time resources, and how a second PUCCH may be transmitted from a second antenna panel, on a second beam, using a second set of frequency resources within the set of time resources.

FIGS. 5A-5C show examples of how a first PUCCH may be transmitted from a first antenna panel, on a first beam, using a first set of spatial resources within a set of time and frequency resources, and how a second PUCCH may be transmitted from a second antenna panel, on a second beam, using a second set of spatial resources within the set of time and frequency resources.

FIGS. 6 and 7 show examples of control signaling options for a multiple antenna panel PUCCH transmission.

FIG. 8 shows an example code block including a PUCCH-CSI-Resource indication.

FIG. 9 shows an example code block including a CSI-reportConfig.

FIG. 10 shows an example code block including a PUCCH-Resource indication.

FIG. 11 shows an example method of wireless communication by a base station, which method may be used to configure a UE to transmit different PUCCHs, using multiple antenna panels, in at least one of an FDM manner or an SDM manner.

FIG. 12 illustrates an example architecture of a wireless communication system, according to embodiments disclosed herein.

FIG. 13 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

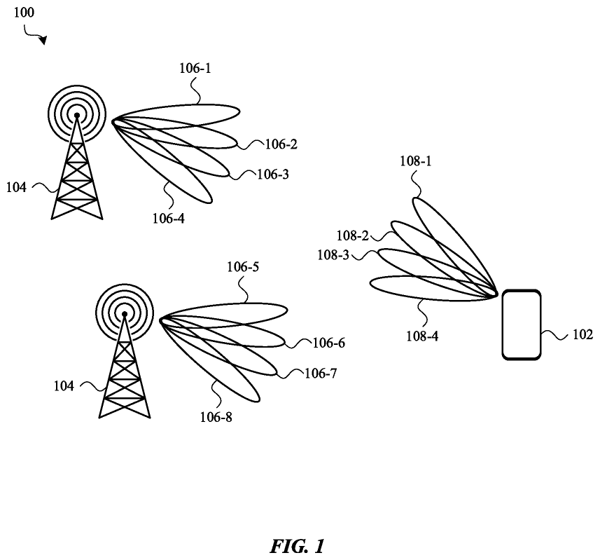

FIG. 1 shows an example wireless communication system 100, according to embodiments described herein. The wireless communication system 100 may operate in accord with the LTE system standards, 5G or NR system standards, or other standards provided by 3GPP technical specifications.

As shown in FIG. 1, the wireless communication system 100 may include a UE 102 and one or more base stations 104 (e.g., eNBs or gNBs). The UE 102 may communicate with one or both of the base stations 104, sequentially (e.g., in a handover scenario) or simultaneously (e.g., in a carrier aggregation (CA) scenario). The UE 102 may also communicate with one or multiple transmission and reception points (multi-TRPs), on one or more base stations 104, in a multi-TRP mode. The UE 102 may also communicate with other base stations 104. In some embodiments, the UE 102 may be one of multiple UEs that simultaneously or contemporaneously communicate with one or both of the base stations 104 (or other base stations). In some embodiments, one or both of the base stations 104, alone or in combination with one or more other base stations, may form part or all of a cellular RAN.

In some cases, one or both of the base stations 104 may transmit one or more DL channels to the UE 102. The DL channels may be transmitted on one or multiple DL beams 106 (e.g., DL beams 106-1, 106-2, 106-3, and/or 106-4, or DL beams 106-5, 106-6, 106-7, and/or 106-8). Similarly, the UE 102 may transmit one or more UL channels to the base station 104. The UL channels may be transmitted on one or multiple UL beams 108 (e.g., UL beam 108-1, 108-2, 108-3, and/or 108-4).

In some cases, the UE 102 and a base station 104 may communicate on a single CC. In other cases, the UE 102 and the base station 104 may communicate on multiple CCs in a carrier aggregation (CA) mode. The UE 102 may also communicate with more than one base station 104 simultaneously over a set of multiple CCs.

In 3GPP Release 17 (Rel-17), a base station can configure a UE to transmit a PUCCH (1 PUCCH) with N repetitions (N>1) to report uplink control information (UCI) on M beams. M is typically equal to 1 or 2, and N is typically equal to 2 or 4, though each variable can assume other values. The values of M and N may be the same or different. The N repetitions of PUCCH are multiplexed in a time division multiplexing (TDM) manner.

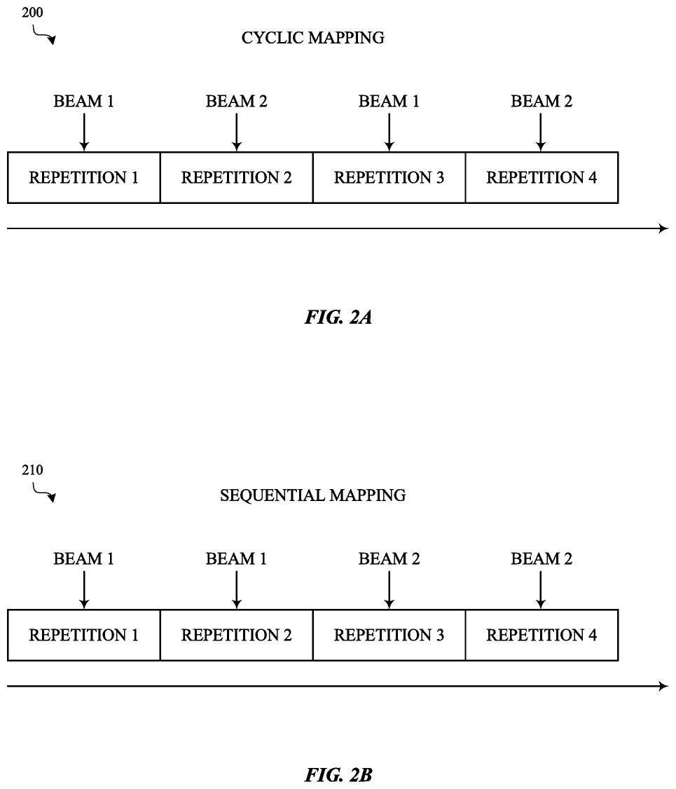

A base station (e.g., a gNB or eNB) may configure a UE (via radio resource control (RRC) signaling) to map the M beams to the N repetitions in a cyclic or sequential manner, as shown in FIGS. 2A and 2B. FIG. 2A shows a cyclic mapping of beams to repetitions, and FIG. 2B show a sequential mapping of beams to repetitions.

As shown in FIG. 2A, a UE may transmit PUCCH on two beams (Beam 1 and Beam 2), mapped to four PUCCH repetitions, in accord with a cyclic beam mapping 200. Thus, Repetition 1 and Repetition 3 are transmitted on Beam 1, and Repetition 2 and Repetition 4 are transmitted on Beam 2. As shown in FIG. 2B, a UE may transmit PUCCH on two beams (Beam 1 and Beam 2), mapped to four PUCCH repetitions, in accord with a sequential beam mapping 210. Thus, Repetition 1 and Repetition 2 are transmitted on Beam 1, and Repetition 3 and Repetition 4 are transmitted on Beam 2.

The beam indication for the cyclic and sequential mapping schemes are signaled by pucch-spatialRelationInfo or a transmission configuration indicator (TCI). The power control parameters (e.g., P0, pathloss reference signal, and closed-loop power process index) for each repetition may be derived based on the power control parameters associated with the indicated pucch-spatialRelationInfo or TCI.

A base station may configure a list of PUCCH resources via RRC signaling and select a PUCCH resource for a UCI report. For a periodic or semi-persistent CSI report, a PUCCH resource may be configured via RRC signaling, using the pucch-CSI-ResourceList in CSI-ReportConfig. Each PUCCH-CSI-Resource may contain a bandwidth part (BWP) identifier (ID) and a PUCCH resource ID. For an aperiodic PUCCH for hybrid automatic repeat request (HARQ) feedback, a PUCCH resource may be selected by downlink control information (DCI). If the number of PUCCH resources configured by resourceList for HARQ feedback is equal to or less than 8, the PUCCH resource may be selected by a PUCCH resource indicator field in DCI. If the number of PUCCH resources configured by resourceList for HARQ feedback is greater than 8, the PUCCH resource may be selected as described in 3GPP Technical Specification (TS) 38.213, § 9.2.3, using the formula:

$${r}_{PUCCH} = \{ \begin{matrix}⌊ \frac{{n}_{CCE , p} \cdot ⌈ {R}_{PUCCH} / 8 ⌉}{{N}_{CCE , p}} ⌋ + & if {Δ}_{PRI} < {R}_{PUCCH} mod 8 \\ {Δ}_{PRI} \cdot ⌈ \frac{{R}_{PUCCH}}{8} ⌉ & \\ ⌊ \frac{{n}_{CCE , p} \cdot ⌈ {R}_{PUCCH} / 8 ⌉}{{N}_{CCE , p}} ⌋ + & if {Δ}_{PRI} \geq {R}_{PUCCH} mod 8 \\ {Δ}_{PRI} \cdot ⌈ \frac{{R}_{PUCCH}}{8} ⌉ + {Δ}_{PRI} mod 8 & \end{matrix} \}$$

where N_{CCE,p} is a number of control channel elements (CCEs) in a control resource set (CORESET) p of the physical downlink control channel (PDCCH) reception for the DCI format described in clause 10.1 of 3GPP TS 38.213, and n_{CCE,p} is the index of a first CCE for the PDCCH reception, and APRI is a value of the PUCCH resource indicator field in the DCI format. If the DCI format does not include a PUCCH resource indicator field, Δ_{PRI}=0.

3GPP Rel-18 will support a multiple antenna panel UE. For a UE with multiple antenna panels, it is possible to transmit a PUCCH with multiple beams in an FDM and/or SDM manner (or in a hybrid FDM or hybrid SDM manner). In this description, control signaling to support multiple antenna panel PUCCH transmission is described. The control signal includes signaling for a transmission scheme selection (e.g., a cyclic or sequential mapping), PUCCH resource selection, and time/frequency/spatial domain resource indication.

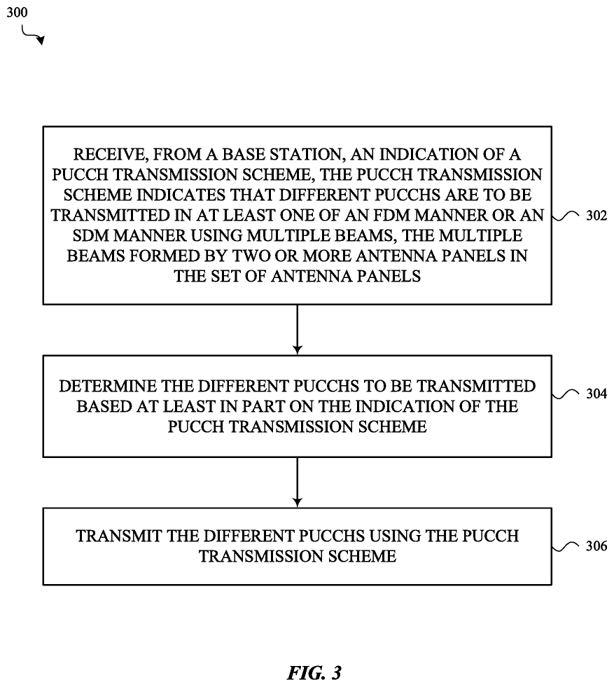

FIG. 3 shows an example method 300 of wireless communication by a UE, which method 300 may be used to transmit different PUCCHs, using multiple antenna panels, in at least one of an FDM manner or an SDM manner. The method 300 may be performed by a processor of the UE, and transmissions and receptions initiated by the processor may be made using a transceiver of the UE, with the transceiver having a set of antenna panels.

At 302, the method 300 may include receiving, from a base station, an indication of a PUCCH transmission scheme. The PUCCH transmission scheme may indicate that different PUCCHs are to be transmitted in at least one of an FDM manner or an SDM manner using multiple beams. The multiple beams may be formed by two or more antenna panels in the set of antenna panels.

At 304, the method 300 may include determining the different PUCCHs to be transmitted based at least in part on the indication of the PUCCH transmission scheme.

At 306, the method 300 may include transmitting the different PUCCHs using the PUCCH transmission scheme. The PUCCHs may be transmitted to the same or different TRPs.

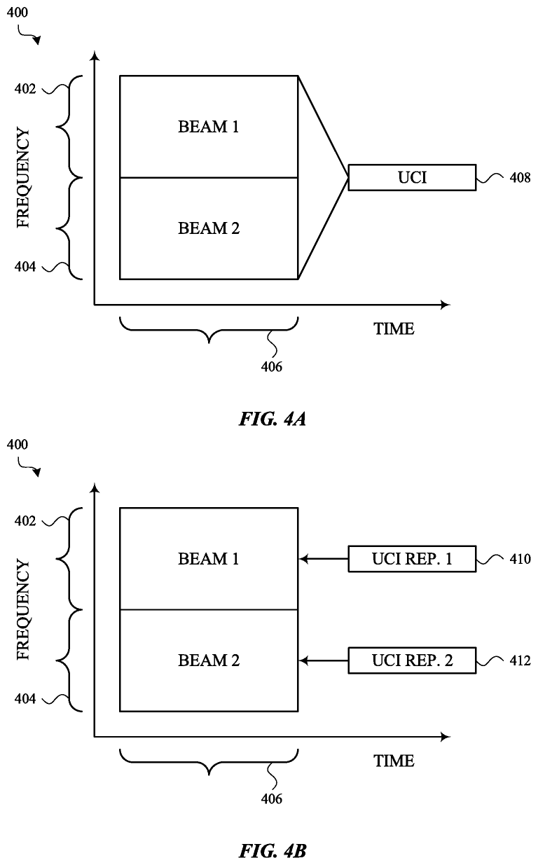

The PUCCH transmission scheme may take various forms. In some embodiments, the PUCCH transmission scheme may indicate that different PUCCHs are to be transmitted in an FDM manner from different antenna panels in the set of antenna panels. For example, as shown in the time-frequency resource graph 400 in each of FIGS. 4A-4C, a first PUCCH may be transmitted from a first antenna panel, on a first beam, using a first set of frequency resources 402 within a set of time resources 406. A second PUCCH may be transmitted from a second antenna panel, on a second beam, using a second set of frequency resources 404 within the set of time resources 406. In this manner, the first and second PUCCHs may be transmitted, simultaneously, using the first and second sets of frequency resources 402, 404.

As shown in FIG. 4A, the different PUCCHs, together, may carry a single instance of UCI. For example, a first portion of the single instance of UCI 408 (e.g., a first 50 coded bits) may be transmitted on the first PUCCH, using the first set of frequency resources 402, and a second portion of the single instance of UCI 408 (e.g., a second 50 coded bits) may be transmitted on the second PUCCH, using the second set of frequency resources 404. The PUCCH transmission scheme illustrated in FIG. 4A may enable the transmission of a larger UCI payload (e.g., a UCI having a greater number of coded bits).

As shown in FIG. 4B, each PUCCH of the different PUCCHs may carry a different UCI repetition. For example, the first PUCCH, transmitted using the first set of frequency resources 402, may carry a first UCI repetition 410. The second PUCCH, transmitted using the second set of frequency resources 404, may carry a second UCI repetition 412. In alternative embodiments, any number of N panels may be used to transmit N UCI repetitions. The PUCCH transmission scheme illustrated in FIG. 4B may improve the reliability of a UCI transmission.

As shown in FIG. 4C, the different PUCCHs may in some cases carry different UCIs. For example, the first PUCCH, transmitted using the first set of frequency resources 402, may carry a first UCI 414. The second PUCCH, transmitted using the second set of frequency resources 404, may carry a second UCI 416. In alternative embodiments, any number of N antenna panels may be used to transmit N PUCCHs carrying N different UCIs. The PUCCH transmission scheme illustrated in FIG. 4C may increase the bandwidth for UCI transmissions.

Although the different sets of frequency, time, and spatial resources shown in FIGS. 4A-4C are shown to include contiguous resources, some or all of the sets of resources may be non-contiguous. In the examples shown in FIGS. 4A-4C, and other described examples, different sets of resources of the same type are understood to be separate (or non-overlapping) sets of resources.

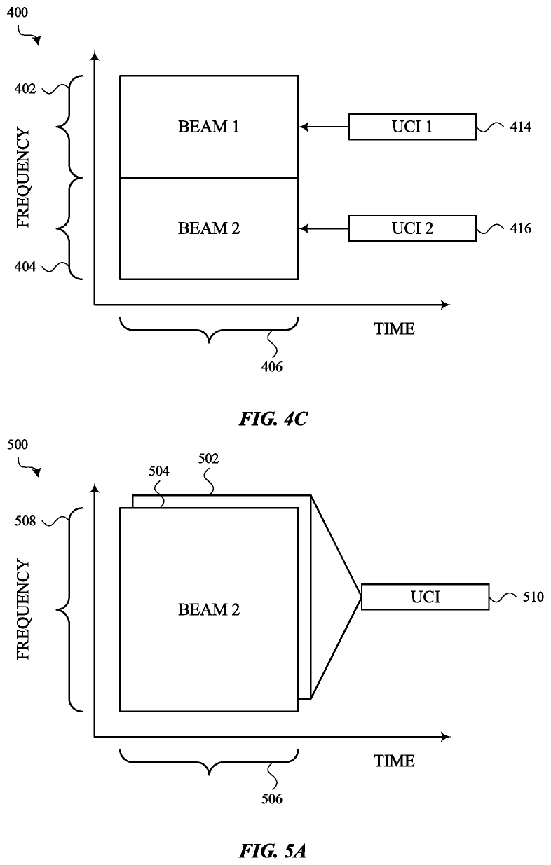

In some embodiments, the PUCCH transmission scheme of FIG. 3 may indicate that different PUCCHs are to be transmitted in an SDM manner (e.g., on different layers) from different antenna panels in the set of antenna panels. For example, as shown in the time-frequency-space resource graph 500 in each of FIGS. 5A-5C, a first PUCCH may be transmitted from a first antenna panel, on a first beam, using a first set of spatial resources 502 within a set of time and frequency resources 506, 508. A second PUCCH may be transmitted from a second antenna panel, on a second beam, using a second set of spatial resources 504 within the set of time and frequency resources 506, 508. In this manner, the first and second PUCCHs may be transmitted, simultaneously, using the first and second sets of spatial resources 502, 504.

As shown in FIG. 5A, the different PUCCHs, together, may carry a single instance of UCI. For example, a first portion of the single instance of UCI 510 (e.g., a first 50 coded bits) may be transmitted on the first PUCCH, using the first set of spatial resources 502, and a second portion of the single instance of UCI 510 (e.g., a second 50 coded bits) may be transmitted on the second PUCCH, using the second set of spatial resources 504. The PUCCH transmission scheme illustrated in FIG. 5A may enable the transmission of a larger UCI payload (e.g., a UCI having a greater number of coded bits).

As shown in FIG. 5B, each PUCCH of the different PUCCHs may carry a different UCI repetition. For example, the first PUCCH, transmitted using the first set of spatial resources 502, may carry a first UCI repetition 512. The second PUCCH, transmitted using the second set of spatial resources 504, may carry a second UCI repetition 514. In alternative embodiments, any number of N panels may be used to transmit N UCI repetitions. The PUCCH transmission scheme illustrated in FIG. 5B may improve the reliability of a UCI transmission.

As shown in FIG. 5C, the different PUCCHs may in some cases carry different UCIs. For example, the first PUCCH, transmitted using the first set of spatial resources 502, may carry a first UCI 516. The second PUCCH, transmitted using the second set of spatial resources 504, may carry a second UCI 518. In alternative embodiments, any number of N antenna panels may be used to transmit N PUCCHs carrying N different UCIs. The PUCCH transmission scheme illustrated in FIG. 5C may increase the bandwidth for UCI transmissions.

Although the different sets of frequency, time, and spatial resources shown in FIGS. 5A-5C are shown to include contiguous resources, some or all of the sets of resources may be non-contiguous.

In addition to multiple antenna panel PUCCH transmission schemes, a UE may at times be configured to switch into a single antenna panel PUCCH transmission scheme (e.g., for transmission of a PUCCH without repetition). A UE may also be configured to switch between single and/or multiple antenna panel PUCCH transmission schemes (e.g., a PUCCH transmission on a single beam and a PUCCH transmission on multiple beams may be multiplexed in a TDM manner). In some cases, a PUCCH transmission scheme may be configured per resource, resource group, bandwidth part (BWP), CC, and/or UE.

In some cases, the PUCCH transmission scheme of FIG. 3 may indicate that different PUCCHs are to be transmitted, from different antenna panels in the set of antenna panels, in a combination of two or more of: the FDM manner, the SDM manner, or a TDM manner. For example, PUCCH transmissions can be multiplexed in a joint FDM and SDM manner, a joint TDM and SDM manner, a joint TDM and FDM manner, or a joint TDM, FDM, and SDM manner, with the PUCCHs transmitted from different panels carrying one UCI, different UCI repetitions, or different UCIs.

For a PUCCH transmission scheme in accord with a joint FDM, SDM, and/or TDM manner, a beam-to-PUCCH transmission occasion (e.g., one or more intersections of time, frequency, and/or space resources) mapping can be predefined or configured by higher layer signaling (e.g., by RRC signaling or a MAC CE) or an indication in DCI.

In some examples, the PUCCH transmission scheme of FIG. 3 may indicate that the different PUCCHs are to be transmitted from different antenna panels in an FDM manner and a TDM manner. In these examples, a base station can configure the UE to use one of the following options.

In a first option, the method 300 may include applying the first beam (Beam 1) to a first set of PUCCH transmission occasions in a first set of frequency resources, in which the first set of frequency resources span a first set of time resources and a second set of time resources, and applying a second beam (Beam 2) to a second set of PUCCH transmission occasions in a second set of frequency resources, in which the second set of frequency resources also span the first set of time resources and the second set of time resources.

In a second option, the method 300 may include applying a first beam (Beam 1) to a first set of PUCCH transmission occasions in a first set of time resources (e.g., even time resources). The first set of time resources include a first set of frequency resources and a second set of frequency resources. The method 300 may also include applying a second beam (Beam 2) to a second set of PUCCH transmission occasions in a second set of time resources (e.g., odd time resources). The second set of time resources includes the first set of frequency resources and the second set of frequency resources.

In a third option, the method 300 may include applying a first beam (Beam 1), formed by a first antenna panel, to a first set of PUCCH transmission occasions. The first set of PUCCH transmission occasions may include a first set of frequency resources in a first set of time resources, and a second set of frequency resources in a second set of time resources. The method 300 may also include applying a second beam (Beam 2), formed by a second antenna panel, to a second set of PUCCH transmission occasions. The second set of PUCCH transmission occasions may include the second set of frequency resources in the first set of time resources, and the first set of frequency resources in the second set of time resources. The third option provides a form of beam hopping.

In other options, a beam-to-PUCCH transmission occasion mapping can include, for example, a sequential mapping in the time domain and a fixed mapping or hopping in the frequency domain, as well as other beam-to-PUCCH transmission occasion mappings.

In some embodiments of the method 300, different PUCCH transmission schemes may be applied to different types of UCI. For example, the PUCCH transmission scheme mentioned at 302 may be a first PUCCH transmission scheme and the method 300 may include transmitting a first type of UCI using the first PUCCH transmission scheme; receiving, from the base station, an indication of a second PUCCH transmission scheme; and transmitting a second type of UCI using the second PUCCH transmission scheme. The transmission of different types of UCI using different PUCCH transmission schemes may be motivated, in some cases, by the associated functionalities and reliability requirements of different types of UCI. For example, hybrid automatic repeat request (HARQ) acknowledgements (ACK) (HARQ-ACK) and scheduling requests (SR) may be relatively more important compared to channel state information (CSI) reports, and may also have higher reliability requirements. In some cases, the UCI repetition scheme described with reference to FIG. 4B or 5B may be used for HARQ-ACK transmission, and the UCI scheme described with reference to FIG. 4A or 5A may be used for CSI reporting (e.g., to minimize the overhead of UCI with a reduced number of resource elements (REs).

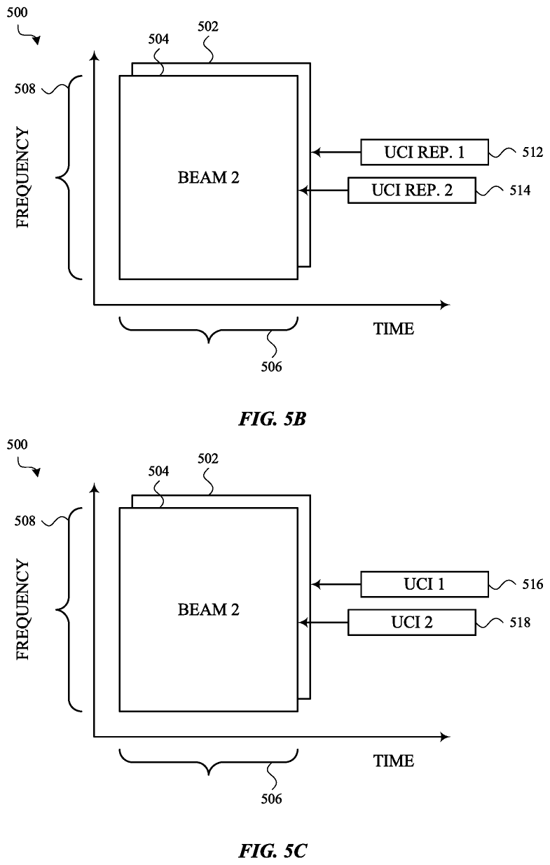

The control signaling for a multiple antenna panel PUCCH transmission may be provided in various ways. In some examples, the method 300 may include receiving, from a base station, an indication of a set of PUCCH resources (e.g., N resources) usable for multiple antenna panel PUCCH transmission. Each PUCCH resource may be associated with a respective beam in a set of beams (i.e., the base station may indicate one beam for one PUCCH resource). Each beam in the set of beams may be associated with (e.g., transmitted from) a respective antenna panel. At least a first PUCCH resource may be associated with a first beam transmitted by a first antenna panel, and at least a second PUCCH resource may be associated with a second beam transmitted by a second antenna panel. A PUCCH transmission scheme may be associated with the first PUCCH resource and the second PUCCH resource, and in some cases other PUCCH resources. FIG. 6 shows an example of this first control signaling option. In the example, some PUCCH resources 602 in a PUCCH resource pool 600 are associated with a first beam transmitted from a first antenna panel (Panel 1), and other PUCCH resources 604 in the PUCCH resource pool 600 are associated with a second beam transmitted from a second antenna panel (Panel 2). A PUCCH transmission scheme may be associated with a first PUCCH resource selected from the PUCCH resources 602, and a second PUCCH resource selected from the PUCCH resources 604.

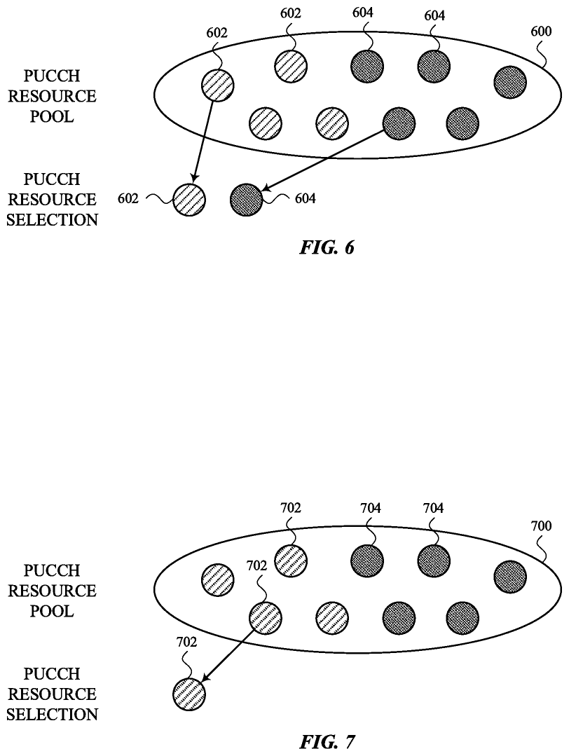

As another control signaling example, a base station may indicate a set of beams (e.g., N beams) that are usable for one PUCCH resource. In this example, the method 300 may in some cases include receiving, from a base station, an indication of a set of PUCCH resources usable for multiple antenna panel PUCCH transmission, and each PUCCH resource may be associated with a respective two or more beams in a set of beams. At least two beams in the respective two or more beams that are associated with a single PUCCH resource may be associated with different antenna panels, and the PUCCH transmission scheme may be associated with at least one PUCCH resource in the set of PUCCH resources. In some cases, the method 300 may also include receiving, from the base station, an indication of a second set of PUCCH resources, which second set of PUCCH resources are usable for single antenna panel PUCCH transmission. The PUCCH transmission scheme (or schemes) that are to be used by the UE may be configured by higher layer signaling (e.g., by RRC signaling or a MAC CE) or an indication in DCI. FIG. 7 shows an example of this second control signaling option. In the example, some PUCCH resources 702 in a PUCCH resource pool 700 are associated with both a first beam transmitted from a first antenna panel (Panel 1) and a second beam transmitted from a second antenna panel (Panel 2). Optionally, other PUCCH resources 704 in the PUCCH resource pool 700 may be associated with only a single beam and a single antenna panel. A PUCCH transmission scheme may be associated with a PUCCH resource selected from the PUCCH resources 702, in which case the PUCCH transmission scheme would be a multiple antenna panel PUCCH transmission scheme; or a PUCCH transmission scheme may be associated with a PUCCH resource selected from the PUCCH resources 704, in which case the PUCCH transmission scheme would be a single antenna panel PUCCH transmission scheme.

Further details, and possible variants, of the control signaling options described with reference to FIGS. 6 and 7 are described below.

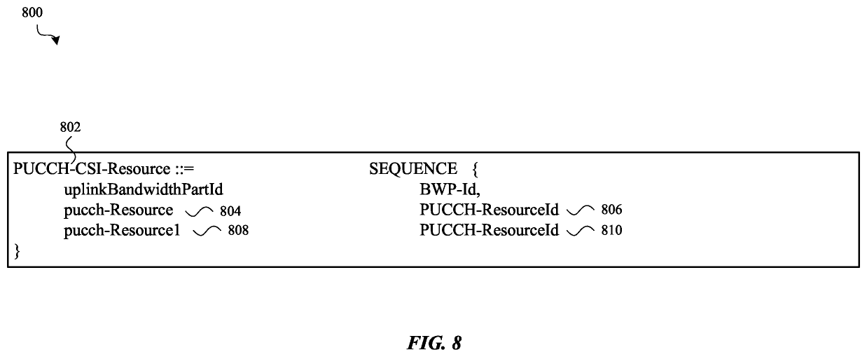

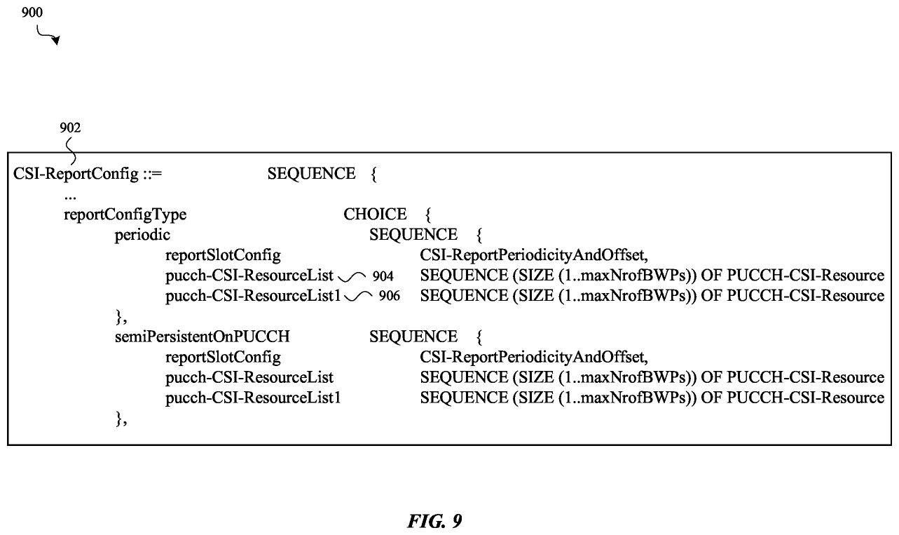

For the first control signaling option (i.e., where each PUCCH resource is associated with a respective single beam), and for a periodic UCI report, a semi-persistent UCI report, or a scheduling request (SR), a base station may identify (or indicate) the PUCCH resources that are to be used in a multiple antenna panel PUCCH transmission scheme in higher layer signaling. For example, RRC signaling may include a PUCCH-CSI-Resource indication 802, as shown in the code block 800 in FIG. 8. The PUCCH-CSI-Resource indication 802 already contains a first PUCCH resource field (pucch-Resource 804) that can be used to identify a PUCCH resource (PUCCH-ResourceId 806) for a single antenna panel PUCCH transmission scheme. A second PUCCH resource field (pucch-Resource field (i.e., pucch-Resource1 808) may be added to the PUCCH-CSI-Resource indication 802 and used to identify a second PUCCH resource (PUCCH-ResourceId1 810) that, together with the first PUCCH resource identified in the pucch-Resource 804 field, may be used in a multiple antenna panel PUCCH transmission scheme. As another example, RRC signaling may also include a CSI report configuration (i.e., CSI-reportConfig 902), as shown in the code block 900 in FIG. 9. The CSI-reportConfig 902 already contains a first PUCCH resource list (PUCCH-CSI-ResourceList 904), from which a first PUCCH resource may be selected, and identified to a UE, for a single antenna panel PUCCH transmission scheme. A second PUCCH resource list (PUCCH-CSI-ResourceList1 906) may be added to the CSI-reportConfig 902, and a PUCCH resource may be selected from each PUCCH resource list, and identified to a UE, for a multiple antenna panel PUCCH transmission scheme. In some cases, additional PUCCH resource fields or lists may be added to the PUCCH-CSI-Resource indication 802 or CSI-reportConfig 902 shown in FIG. 8 or 9.

For the first control signaling option (i.e., where each PUCCH resource is associated with a respective single beam), and for HARQ feedback, a base station may identify (or indicate) the PUCCH resources that are to be used in a multiple antenna panel PUCCH transmission scheme in various ways. For example, the method 300 may include receiving, from a base station, one or more mappings of DCI codepoints to respective sets of PUCCH resources. Each DCI codepoint may be mapped to one, or more than one, PUCCH resource. In some cases, each DCI codepoint may be an rPUCCH. The mapping(s) of DCI codepoints to sets of PUCCH resources may be received, in some cases, via RRC signaling or a MAC CE. A mapping may be received per DCI format, or may be applied to all DCI formats (e.g., DCI format 1_1 and DCI format 1_2). The method 300 may further include receiving, from a base station and in DCI, a DCI codepoint. The DCI codepoint may then be used, as an index to a mapping of the DCI codepoint to a set of PUCCH resources, to identify the set of PUCCH resources (e.g., a first PUCCH resource and a second PUCCH resource) that are to be used in a multiple antenna panel PUCCH transmission scheme. As another example, the method 300 may include receiving, from a base station and in DCI, a first indication of a first PUCCH resource (e.g., a first PUCCH resource ID) and a second indication of a second PUCCH resource (e.g., a second PUCCH resource ID) that are to be used in a multiple antenna panel PUCCH transmission scheme. In some cases, a field in the second indication, a value of the second indication, or an additional indication may be used to indicate there is no second PUCCH resource. In some cases, one or more RRC parameter(s) can be introduced to enable/disable the second indication for each DCI format (e.g., for DCI format 1_1 or DCI format 1_2).

For the first control signaling option (i.e., where each PUCCH resource is associated with a respective single beam), and for a periodic CSI report, a semi-persistent CSI report, an SR, or an aperiodic PUCCH transmission, a base station may configure a linkage between PUCCH resources that are to be used in a multiple antenna panel PUCCH transmission scheme. For example, the method 300 may include receiving, from a base station, an indication of linked PUCCH resources (e.g., N linked PUCCH resources). The linkage may be received, for example, in RRC signaling or a MAC CE. When one of the linked PUCCH resources is selected (e.g., by an indication in DCI), the linkage of PUCCH resources indicates to a UE that all of the linked PUCCH resources are to be used in a multiple antenna panel PUCCH transmission scheme. Alternatively, a base station may dynamically indicate, in DCI, whether the remaining ones of linked PUCCH resources should be used (or not used).

For the first control signaling option, and in some embodiments, the multiple PUCCH resources that are used in a multiple antenna panel PUCCH transmission scheme may need to be configured with the same PUCCH format, and/or number of PUCCH repetitions, and/or number of resource blocks (RBs), and/or number of symbols, and/or a same value of a hopping flag (e.g., interslotFrequencyHopping), and/or simultaneous-HARQ-ACK-CSI.

In accord with the method of FIG. 3, a base station can indicate a PUCCH transmission scheme (e.g., transmission of one UCI, or multiple UCI repetitions, or multiple different UCIs) for N selected PUCCH resources by higher layer signaling (e.g., by RRC signaling or a MAC CE) or an indication in DCI, and the multiplexing scheme (FDM, SDM, and/or TDM) may be based on the time/frequency/space resource allocation for the PUCCH resources.

When a PUCCH transmission scheme is configured to provide different UCIs (e.g., N UCIs) transmitted from different antenna panels (e.g., the PUCCH transmission scheme described with reference to FIG. 4C or 5C), the information to be reported in the N UCIs may be divided into N groups of information, and each group of information may be assigned to a different UCI. In some embodiments, the groups may be formed based on the TRPs to which the PUCCHs/UCIs are transmitted in a multi-TRP operation. That is, different antenna panels may transmit their different beams, and associated PUCCHs/UCIs, to different TRPs, such that different PUCCHs/UCIs are initially received at different TRPs. In one example of this sort of information group-to-UCI mapping, the HARQ-ACK or CSI for a particular TRP may be included in a group of information that is to be transmitted in a PUCCH/UCI that is to be received by the particular TRP (i.e., HARQ-ACK or CSI for a TRP x may be transmitted in a PUCCH/UCI that is to be received by TRP x).

Alternatively, the grouping and assignment of information to different UCIs may be based on the content of the information. In one example, one PUCCH/UCI is used to report HARQ-ACK for a first codeword, and another PUCCH/UCI is used to report HARQ-ACK for a second codeword. In another example, one PUCCH/UCI is used to report HARQ-ACK, and another PUCCH/UCI is used to report CSI. In another example, one PUCCH/UCI is used to report SRs, and another PUCCH/UCI is used to report HARQ-ACK and/or CSI.

For the second control signaling option (i.e., where at least some PUCCH resources are associated with multiple beams), a base station can indicate a set of beams (e.g., N beams) for a PUCCH resource by higher layer signaling (e.g., by RRC signaling or a MAC CE) or an indication in DCI. The base station can also indicate a PUCCH transmission scheme for each PUCCH resource by higher layer signaling (e.g., by RRC signaling or a MAC CE) or an indication in DCI. Alternatively, a second PUCCH-CSI-ResourceList1 can be introduced in CSI-reportConfig.

When the second control signaling option is used for an SDM-based PUCCH transmission scheme, an additional scramble ID can be configured, so that transmissions from different antenna panels are scrambled using different scramble IDs. In some cases, a scramble ID-to-beam mapping can be predefined (e.g., a PUCCH transmitted on a first beam may be based on a first scramble ID, and a PUCCH transmitted on the second beam may be based on a second scramble ID). Alternatively, the scramble ID-to-beam mapping may be dynamically configured by a base station.

Alternatively or additionally, and when the second control signaling option is used for an SDM-based PUCCH transmission scheme, an additional initial cyclic shift can be configured for PUCCH format 0/1, and an additional occ-index can be configured for PUCCH format 4. The initial cyclic shift-to-beam mapping can be predefined (e.g., a PUCCH transmitted on a first beam may be based on a first initial cyclic shift, and a PUCCH transmitted on a second beam may be based on a second initial cyclic shift). Alternatively, the initial cyclic shift-to-beam mapping may be dynamically configured by a base station.

When the second control signaling option is used for an FDM-based PUCCH transmission, an additional starting physical resource block (PRB) (startingPRB) can be configured for each PUCCH resource transmitted from an antenna panel other than a default or primary antenna panel. The startingPRB-to-beam mapping can be predefined (e.g., a PUCCH transmitted on a first beam may be based on a first startingPRB, and a PUCCH transmitted on a second beam may be based on a second startingPRB). Alternatively the startingPRB-to-beam mapping may be dynamically configured by a base station. As an extension, an additional PRB hopping field (secondHopPRB) can be configured, which may be used to indicate the index of a first PRB after frequency hopping from one PUCCH to another PUCCH. As another extension, and to support the PUCCH transmission scheme described with reference to FIG. 4C or 5C, an additional format can be configured to transmit a second UCI.

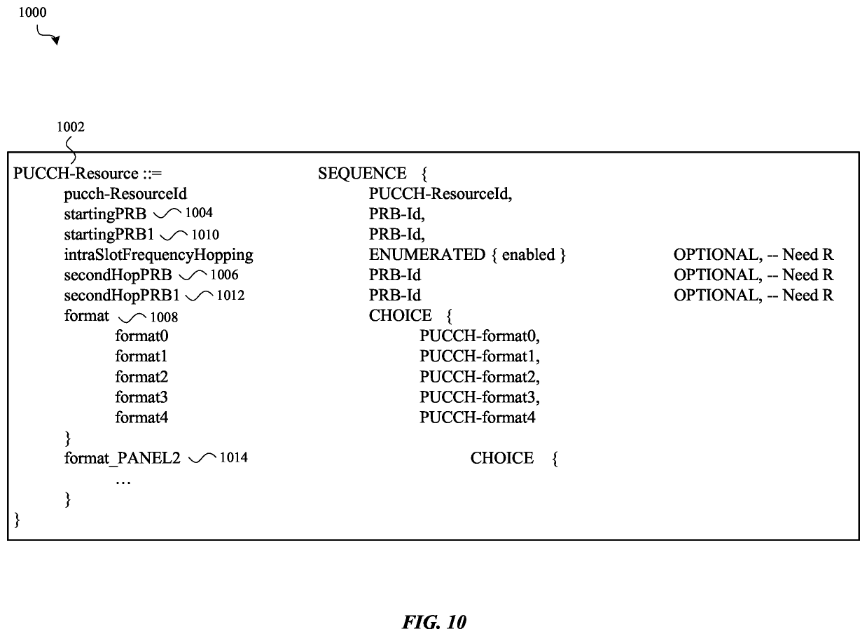

In some cases, RRC signaling may include a PUCCH-Resource indication 1002, as shown in the code block 1000 in FIG. 10. The PUCCH-Resource indication 1002 already contains a first starting PRB field (startingPRB 1004), a first PRB hopping field (secondHopPRB 1006), and a number of PUCCH formats 1008 (e.g., format0, format1, format2, format3, and format4). As described above, the PUCCH-Resource indication 1002 may be modified to include one or more of a second starting PRB field (startingPRB1 1010), a second PRB hopping field (secondHopPRB1 1012), and a new PUCCH format (format_PANEL2 1014). The additional field(s) may be used to support an FDM-based PUCCH transmission that uses the second control signaling option.

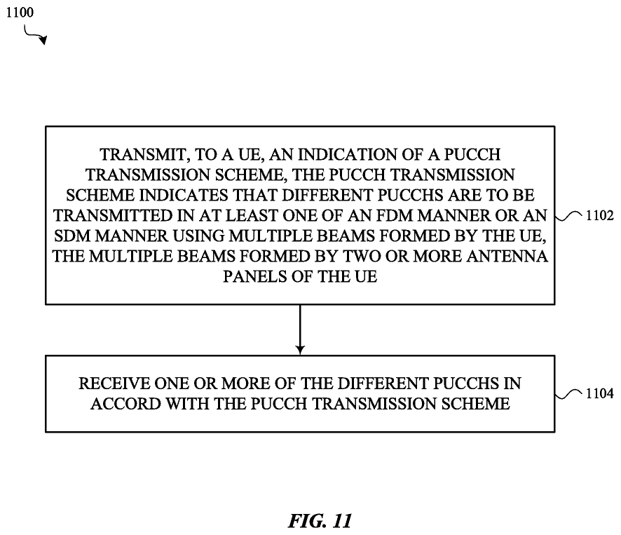

FIG. 11 shows an example method 1100 of wireless communication by a base station (e.g., a gNB or eNB), which method 1100 may be used to configure a UE to transmit different PUCCHs, using multiple antenna panels, in at least one of an FDM manner or an SDM manner. The method 1100 may be performed by a processor of the base station, and transmissions and receptions initiated by the processor may be made using a transceiver of the base station.

At 1102, the method 1100 may include transmitting, to a UE, an indication of a PUCCH transmission scheme. The PUCCH transmission scheme may indicate that different PUCCHs are to be transmitted in at least one of an FDM manner or an SDM manner using multiple beams formed by the UE. The multiple beams may be formed by two or more antenna panels of the UE.

At 1104, the method 1100 may include receiving one or more of the different PUCCHs in accord with the PUCCH transmission scheme. The PUCCHs may be received at the same or different TRPs.

Embodiments contemplated herein include an apparatus having means to perform one or more elements of the method 300 or 1100. In the context of method 300, this apparatus may be, for example, an apparatus of a UE (such as a wireless device 1302 that is a UE, as described herein). In the context of method 1100, this apparatus may be, for example, an apparatus of a base station (such as a network device 1320 that is a base station, as described herein).

Embodiments contemplated herein include one or more non-transitory computer-readable media storing instructions to cause an electronic device, upon execution of the instructions by one or more processors of the electronic device, to perform one or more elements of the method 300 or 1100. In the context of method 300, this non-transitory computer-readable media may be, for example, a memory of a UE (such as a memory 1306 of a wireless device 1302 that is a UE, as described herein). In the context of method 1100, this non-transitory computer-readable media may be, for example, a memory of a base station (such as a memory 1324 of a network device 1320 that is a base station, as described herein).

Embodiments contemplated herein include an apparatus having logic, modules, or circuitry to perform one or more elements of the method 300 or 1100. In the context of method 300, this apparatus may be, for example, an apparatus of a UE (such as a wireless device 1302 that is a UE, as described herein). In the context of method 1100, this apparatus may be, for example, an apparatus of a base station (such as a network device 1320 that is a base station, as described herein).

Embodiments contemplated herein include an apparatus having one or more processors and one or more computer-readable media, using or storing instructions that, when executed by the one or more processors, cause the one or more processors to perform one or more elements of the method 300 or 1100. In the context of method 300, this apparatus may be, for example, an apparatus of a UE (such as a wireless device 1302 that is a UE, as described herein). In the context of the method 1100, this apparatus may be, for example, an apparatus of a base station (such as a network device 1320 that is a base station, as described herein).

Embodiments contemplated herein include a signal as described in or related to one or more elements of the method 300 or 1100.

Embodiments contemplated herein include a computer program or computer program product having instructions, wherein execution of the program by a processor causes the processor to carry out one or more elements of the method 300 or 1100. In the context of method 300, the processor may be a processor of a UE (such as a processor(s) 1304 of a wireless device 1302 that is a UE, as described herein), and the instructions may be, for example, located in the processor and/or on a memory of the UE (such as a memory 1306 of a wireless device 1302 that is a UE, as described herein). In the context of method 1100, the processor may be a processor of a base station (such as a processor(s) 1322 of a network device 1320 that is a base station, as described herein), and the instructions may be, for example, located in the processor and/or on a memory of the base station (such as a memory 1324 of a network device 1320 that is a base station, as described herein).

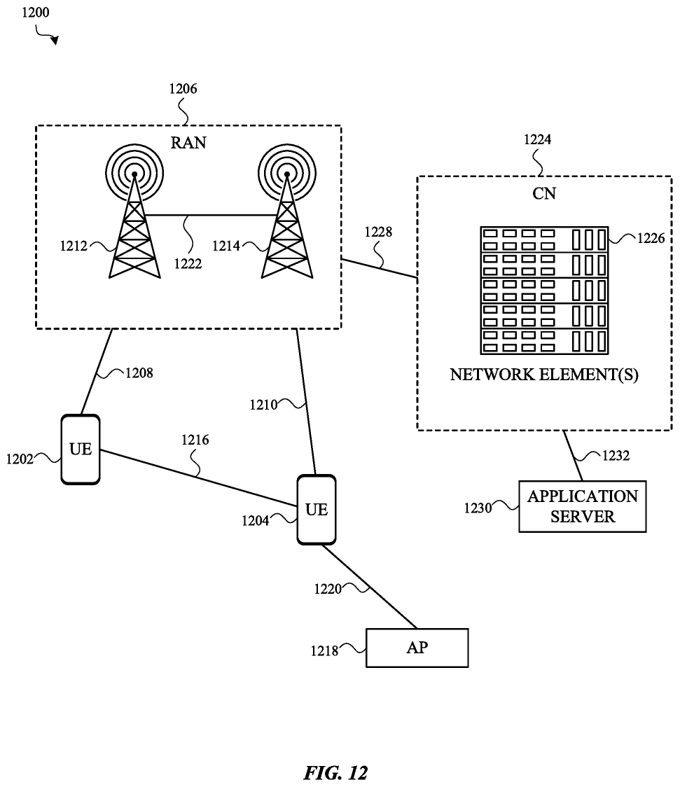

FIG. 12 illustrates an example architecture of a wireless communication system 1200, according to embodiments disclosed herein. The following description is provided for an example wireless communication system 1200 that operates in conjunction with the LTE system standards and/or 5G or NR system standards as provided by 3GPP technical specifications.

As shown by FIG. 12, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks), but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more base stations, such as base station 1212 and base station 1214, that enable the connection 1208 and connection 1210.

In this example, the connection 1208 and connection 1210 are air interfaces to enable such communicative coupling, and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In embodiments, the UE 1202 and UE 1204 can be configured to communicate using orthogonal frequency division multiplexing (OFDM) communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more base stations (e.g., two or more eNBs and the like) that connect to an EPC, and/or between two eNBs connecting to the EPC. In embodiments where the wireless communication system 1200 is an NR system (e.g., when CN 1224 is a 5GC), the interface 1222 may be an Xn interface. The Xn interface is defined between two or more base stations (e.g., two or more gNBs and the like) that connect to 5GC, between a base station 1212 (e.g., a gNB) connecting to 5GC and an eNB, and/or between two eNBs connecting to 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VoIP sessions, group communication sessions, etc.) for the UE 1202 and UE 1204 via the CN 1224. The application server 1230 may communicate with the CN 1224 through an IP communications interface 1232.

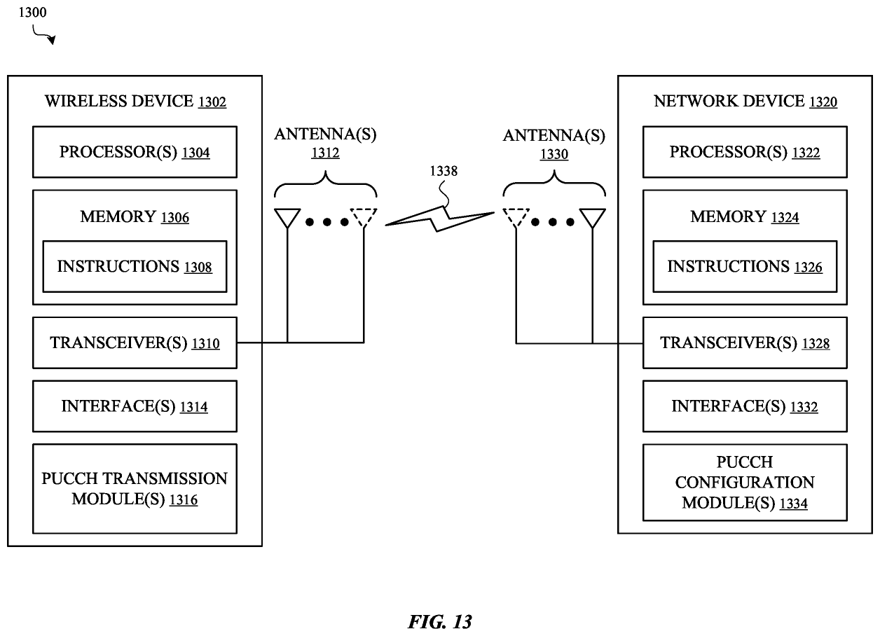

FIG. 13 illustrates a system 1300 for performing signaling 1338 between a wireless device 1302 and a network device 1320, according to embodiments disclosed herein. The system 1300 may be a portion of a wireless communications system as herein described. The wireless device 1302 may be, for example, a UE of a wireless communication system. The network device 1320 may be, for example, a base station (e.g., an eNB or a gNB) of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter and/or receiver circuitry that use the antenna(s) 1312 of the wireless device 1302 to facilitate signaling (e.g., the signaling 1338) to and/or from the wireless device 1302 with other devices (e.g., the network device 1320) according to corresponding RATs.

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include PUCCH transmission module 1316. The PUCCH transmission module 1316 may be implemented via hardware, software, or combinations thereof. For example, the PUCCH transmission module 1316 may be implemented as a processor, circuit, and/or instructions 1308 stored in the memory 1306 and executed by the processor(s) 1304. In some examples, the PUCCH transmission module 1316 may be integrated within the processor(s) 1304 and/or the transceiver(s) 1310. For example, the PUCCH transmission module 1316 may be implemented by a combination of software components (e.g., executed by a DSP or a general processor) and hardware components (e.g., logic gates and circuitry) within the processor(s) 1304 or the transceiver(s) 1310.

The PUCCH transmission module 1316 may be used for various aspects of the present disclosure, for example, aspects of FIGS. 1-10. The PUCCH transmission module 1316 may be used, for example, to configure and transmit one or more multiple PUCCHs.

The network device 1320 may include one or more processor(s) 1322. The processor(s) 1322 may execute instructions such that various operations of the network device 1320 are performed, as described herein. The processor(s) 1322 may include one or more baseband processors implemented using, for example, a CPU, a DSP, an ASIC, a controller, an FPGA device, another hardware device, a firmware device, or any combination thereof configured to perform the operations described herein.

The network device 1320 may include a memory 1324. The memory 1324 may be a non-transitory computer-readable storage medium that stores instructions 1326 (which may include, for example, the instructions being executed by the processor(s) 1322). The instructions 1326 may also be referred to as program code or a computer program. The memory 1324 may also store data used by, and results computed by, the processor(s) 1322.

The network device 1320 may include one or more transceiver(s) 1328 that may include RF transmitter and/or receiver circuitry that use the antenna(s) 1330 of the network device 1320 to facilitate signaling (e.g., the signaling 1338) to and/or from the network device 1320 with other devices (e.g., the wireless device 1302) according to corresponding RATs.

The network device 1320 may include one or more antenna(s) 1330 (e.g., one, two, four, or more). In embodiments having multiple antenna(s) 1330, the network device 1320 may perform MIMO, digital beamforming, analog beamforming, beam steering, etc., as has been described.

The network device 1320 may include one or more interface(s) 1332. The interface(s) 1332 may be used to provide input to or output from the network device 1320. For example, a network device 1320 that is a base station may include interface(s) 1332 made up of transmitters, receivers, and other circuitry (e.g., other than the transceiver(s) 1328/antenna(s) 1330 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1320 may include a PUCCH configuration module 1334. The PUCCH configuration module 1334 may be implemented via hardware, software, or combinations thereof. For example, the PUCCH configuration module 1334 may be implemented as a processor, circuit, and/or instructions 1326 stored in the memory 1324 and executed by the processor(s) 1322. In some examples, the PUCCH configuration module 1334 may be integrated within the processor(s) 1322 and/or the transceiver(s) 1328. For example, the PUCCH configuration module 1334 may be implemented by a combination of software components (e.g., executed by a DSP or a general processor) and hardware components (e.g., logic gates and circuitry) within the processor(s) 1322 or the transceiver(s) 1328.

The PUCCH configuration module 1334 may be used for various aspects of the present disclosure, for example, aspects of FIGS. 1-10. The PUCCH configuration module 1334 may be used, for example, to configure the transmission of one or more multiple PUCCHs by a UE.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver having a set of antenna panels; and
a processor configured to,
receive from a base station, via the transceiver, an indication of a physical uplink control channel (PUCCH) transmission scheme, the PUCCH transmission scheme indicates that different PUCCHs are to be transmitted in at least one of a frequency division multiplexing (FDM) manner or a spatial division multiplexing (SDM) manner using multiple beams, the multiple beams formed by two or more antenna panels in the set of antenna panels;
determine the different PUCCHs to be transmitted based at least in part on the indication of the PUCCH transmission scheme; and
transmit the different PUCCHs, via the transceiver, using the PUCCH transmission scheme.

2. The UE of claim 1, wherein:
the PUCCH transmission scheme indicates the different PUCCHs are to be transmitted in the FDM manner, from different antenna panels in the set of antenna panels; and
the different PUCCHs, together, carry a single instance of uplink control information (UCI).

3. The UE of claim 1, wherein:
the PUCCH transmission scheme indicates the different PUCCHs are to be transmitted in the FDM manner, from different antenna panels in the set of antenna panels; and
each PUCCH of the different PUCCHs carries a different uplink control information (UCI) repetition.

4. The UE of claim 1, wherein:
the PUCCH transmission scheme indicates the different PUCCHs are to be transmitted in the FDM manner, from different antenna panels in the set of antenna panels; and
the different PUCCHs carry different uplink control information (UCIs).

5. The UE of claim 4, wherein different information is assigned to the different UCIs based on the transmissions of the different UCIs to different transmission and reception points (TRPs).

6. The UE of claim 4, wherein different information is assigned to the different UCIs based on a content of the different information.

7. The UE of claim 1, wherein:
the PUCCH transmission scheme indicates the different PUCCHs are to be transmitted in the SDM manner, from different antenna panels in the set of antenna panels; and
the different PUCCHs, together, carry a single instance of uplink control information (UCI).

8. The UE of claim 1, wherein:
the PUCCH transmission scheme indicates the different PUCCHs are to be transmitted in the SDM manner, from different antenna panels in the set of antenna panels; and
each PUCCH of the different PUCCHs carries a different uplink control information (UCI) repetition.

9. The UE of claim 1, wherein:
the PUCCH transmission scheme indicates the different PUCCHs are to be transmitted in the SDM manner, from different antenna panels in the set of antenna panels; and
the different PUCCHs carry different uplink control information (UCIs).

10. The UE of claim 1, wherein the PUCCH transmission scheme indicates the different PUCCHs are to be transmitted, from different antenna panels in the set of antenna panels, in a combination of two or more of the FDM manner, the SDM manner, or a time division multiplexing (TDM) manner.

11. The UE of claim 1, wherein:
the PUCCH transmission scheme indicates the different PUCCHs are to be transmitted from different antenna panels, of two or more antenna panels in the set of antenna panels, in the FDM manner and a time division multiplexing (TDM) manner;
the processor is configured to,
apply a first beam to a first set of PUCCH transmission occasions in a first set of frequency resources, the first set of frequency resources spanning a first set of time resources and a second set of time resources; and
apply a second beam to a second set of PUCCH transmission occasions in a second set of frequency resources, the second set of frequency resources spanning the first set of time resources and the second set of time resources;
the first set of frequency resources is separate from the second set of frequency resources; and
the first set of time resources is separate from the second set of time resources.

12. The UE of claim 1, wherein:
the PUCCH transmission scheme indicates the different PUCCHs are to be transmitted from different antenna panels, of two or more antenna panels in the set of antenna panels, in the FDM manner and a time division multiplexing (TDM) manner;
the processor is configured to,
apply a first beam to a first set of PUCCH transmission occasions in a first set of time resources, the first set of time resources including a first set of frequency resources and a second set of frequency resources; and
apply a second beam to a second set of PUCCH transmission occasions in a second set of time resources, the second set of time resources including the first set of frequency resources and the second set of frequency resources;
the first set of frequency resources is separate from the second set of frequency resources; and
the first set of time resources is separate from the second set of time resources.

13. The UE of claim 1, wherein:
the PUCCH transmission scheme indicates the different PUCCHs are to be transmitted from different antenna panels, of two or more antenna panels in the set of antenna panels, in the FDM manner and a time division multiplexing (TDM) manner; and
the processor is configured to,
apply a first beam, formed by a first antenna panel, to a first set of PUCCH transmission occasions, the first set of PUCCH transmission occasions includes a first set of frequency resources in a first set of time resources, and a second set of frequency resources in a second set of time resources; and
apply a second beam, formed by a second antenna panel, to a second set of PUCCH transmission occasions, the second set of PUCCH transmission occasions includes the second set of frequency resources in the first set of time resources, and the first set of frequency resources in the second set of time resources;
the first set of frequency resources is separate from the second set of frequency resources; and
the first set of time resources is separate from the second set of time resources.

14. The UE of claim 1, wherein:
the PUCCH transmission scheme is a first PUCCH transmission scheme; and
the processor is configured to,
transmit a first type of uplink control information (UCI), via the transceiver using the first PUCCH transmission scheme;
receive from the base station, via the transceiver, an indication of a second PUCCH transmission scheme; and
transmit a second type of UCI, via the transceiver, using the second PUCCH transmission scheme.

15. The UE of claim 1, wherein:
the processor is configured to receive from the base station, via the transceiver, an indication of a set of PUCCH resources usable for multiple antenna panel PUCCH transmission;
each PUCCH resource is associated with a respective beam in a set of beams;
each beam in the set of beams is associated with a respective antenna panel;
at least a first PUCCH resource is associated with a first beam transmitted by a first antenna panel, and at least a second PUCCH resource is associated with a second beam transmitted by a second antenna panel; and
the PUCCH transmission scheme is associated with at least the first PUCCH resource and the second PUCCH resource.

16. The UE of claim 15, wherein:
the set of PUCCH resources is identified to the UE in a channel state information (CSI)-ReportConfig containing a first PUCCH-CSI-ResourceList and a second PUCCH-CSI-ResourceList;
the first PUCCH resource is identified to the UE as a selection from the first PUCCH-CSI-ResourceList; and
the second PUCCH resource is identified to the UE as a selection from the second PUCCH-CSI-ResourceList.

17. The UE of claim 15, wherein:
the processor is configured to,
receive from the base station, via the transceiver, a mapping of a downlink control information (DCI) codepoint to the set of PUCCH resources;
receive from the base station, in DCI, the DCI codepoint; and
use the DCI codepoint and the mapping of the DCI codepoint to the set of PUCCH resources to identify the first PUCCH resource and the second PUCCH resource.

18. The UE of claim 15, wherein the processor is configured to receive from the base station, in downlink control information (DCI), indications of the first PUCCH resource and the second PUCCH resource.

19. The UE of claim 15, wherein:
the processor is configured to,
receive from the base station, via the transceiver, an indication of linked PUCCH resources;
receive from the base station, in downlink control information (DCI), an indication of the first PUCCH resource; and
identify the second PUCCH resource as a PUCCH resource linked with the first PUCCH resource.

20. The UE of claim 1, wherein:
the processor is configured to receive from the base station, via the transceiver, an indication of a set of PUCCH resources usable for multiple antenna panel PUCCH transmission;
each PUCCH resource is associated with a respective two or more beams in a set of beams;
at least two beams in the respective two or more beams associated with a PUCCH resource are associated with different antenna panels; and
the PUCCH transmission scheme is associated with at least one PUCCH resource in the set of PUCCH resources.
